(19) United States
(12) Patent Application Publication
(10) Pub. No.: US 2012/0040711 A1
(43) Pub. Date: Feb. 16, 2012

(54) MOBILE TELEPHONE ENABLING A USER TO ANSWER A CALL WITHOUT PRESSING A BUTTON

(76) Inventor: Siu Ling Wong, Hong Kong Science Park (HK)

(21) Appl. No.: 12/854,294

(22) Filed: Aug. 11, 2010

(51) Int. Cl. H04W 88/02; G08B 21/00

(52) U.S. Cl. 455/550.1; 340/686.6

(57) ABSTRACT

A mobile communication device includes a device body, one or more capacitive sensors each having a single electrode that varies depending on a user's hand position in the vicinity of the mobile communication device, an oscillator that can generate an oscillating signal applied to each of the capacitive sensors, and a capacitance-frequency converter circuit that can convert the frequency of the oscillating signal to the capacitance of each of the capacitive sensors. The capacitance-frequency converter circuit can activate a plurality of functions in response to different positions of the user's hand in the vicinity of the device body.

### BACKGROUND

The present disclosure relates to mobile communication devices such as mobile telephones.

A typical mobile telephone composes of a body, speaker unit, and buttons on the body that can receive commands from users. To receive a call, a user needs to press the ‘answer’ button. In some mobile telephones, however, the button is too small for user to press easily. The problem is aggravated when the user has to find the button to receive the call in a limited time before the caller hangs up. It is not uncommon that a user mistakenly presses the ‘cancel’ button instead of the ‘answer’ button. Moreover, when a user is driving a vehicle, it is difficult for the user to press a button to answer the call without being distracted from driving safely. Additionally, when a user has dirty hands or is holding something in hands, the user cannot easily press the ‘answer’ button to answer the call.

Therefore, there is a need for a user to answer calls on mobile telephone without pressing a button on the mobile telephone.

### SUMMARY OF THE INVENTION

The disclosed invention apparatus allows a user to answer mobile phones without the need to press a button on the phone, which allows a user pre-occupied by another task such as driving, holding articles in hand, or doing work with dirty hands to easily answer a call on the mobile telephone. In another aspect, the present application allows a user to perform a plurality of functions without the need to press a button or to turn a wheel. The plurality of functions can include answering calls, changing volume, silencing a phone, or turning on vibration mode, etc.

In another aspect, the present application discloses simple design for a sensing system. The disclosed capacitive sensor includes a single electrode that can be flexibly mounted in a mobile telephone. The disclosed capacitance sensor does not have the limitations in physical layout and restriction on hand positions that exist in a pair of electrodes, which simplifies the device and reduces cost.

In a general aspect, the present invention relates to a mobile communication device that includes a device body; one or more capacitive sensors each having a single electrode; an oscillator that can generate an oscillating signal applied to each of the one or more capacitive sensors; a capacitance-frequency converter circuit that can convert the frequency of the oscillating signal to the capacitance of each of the one or more capacitive sensors; and a call-answer circuit coupled to the capacitance-frequency converter circuit, wherein the call-answer circuit can be activated when the capacitance of the capacitive sensor changes by a predetermined amount or reaches a predetermined value when a user's hand moves to the proximity of the device body or touches the device body.

Implementations of the system may include one or more of the following. Each of the one or more capacitive sensors can change its capacitance when a user's hand is in the proximity of but not in touch with the device body. Each of the one or more capacitive sensors can change its capacitance when a user's hand is in touch with the device body. The device body can include a top case and a bottom case, wherein the single electrode of one of the one or more capacitive sensors is positioned between the top case and the lower case. The top case can include a display window and a keypad, wherein the single electrode has the form of a plate having openings under the display window and the keypad. The top case can include a display window and a keypad, wherein the single electrode is in the form of a plate and is positioned under the keypad. The mobile communication device can further include an answer button on the device body, wherein the call-answer circuit is coupled to the answer button and can be activated when the answer button is pressed.

In another general aspect, the present invention relates to a mobile communication device that includes a device body; one or more capacitive sensors each having a capacitance that varies depending on a user's hand position in the vicinity of the mobile communication device; an oscillator that can generate an oscillating signal applied to each of the one or more capacitive sensors; a capacitance-frequency converter circuit that can convert the frequency of the oscillating signal to the capacitance of each of the one or more capacitive sensors; a call-answer circuit coupled to the capacitance-frequency converter circuit; and a volume-control circuit coupled to the capacitance-frequency converter circuit, wherein the capacitance-frequency converter circuit can activate the call-answer circuit in response to a first position of the user's hand and to activate the volume-control circuit in response to a first position of the user's hand.

Implementations of the system may include one or more of the following. At least one of the one or more capacitive sensors can include a single electrode. At least one of the one or more capacitive sensors can change its capacitance when a user's hand is in the proximity of the device body or in touch with the device body. At least one of the one or more capacitive sensors can have a first capacitance when the user's hand is at the first position and a second capacitance when the user's hand is at the second position. The capacitance-frequency converter circuit can convert a first frequency of the oscillating signal to the first capacitance when the user's hand is at the first position, and wherein the capacitance-frequency converter circuit configured to convert a second frequency of the oscillating signal to the second capacitance when the user's hand is at the second position. The device body can include a top case and a bottom case, wherein the single electrode of one of the one or more capacitive sensors is positioned between the top case and the lower case. The top case can include a display window and a keypad, wherein the single electrode can have the form of a plate having openings under the display window and the keypad. The top case can include a display window and a keypad, wherein the single electrode can be in the form of a plate and is positioned under the keypad.

In another general aspect, the present invention relates to a mobile communication device which includes a device body; one or more capacitive sensors each having a single electrode that varies depending on a user's hand position in the vicinity of the mobile communication device; an oscillator that can generate an oscillating signal applied to each of the one or more capacitive sensors; and a capacitance-frequency converter circuit that can convert the frequency of the oscillating signal to the capacitance of each of the one or more capacitive sensor, wherein the capacitance-frequency converter circuit can activate a plurality of functions in response to different positions of the user's hand in the vicinity of the device body.

Implementations of the system may include one or more of the following. The plurality of functions can include call answering, volume control, volume silencing, or the turning on the vibration mode. The user's hand at different positions can change the capacitances of the one or more capacitive sensor by predetermined amounts or to predetermined values. The one or more capacitive sensor can change their respective capacitance when the user's hand is in the proximity of the device body or in touch with the device body.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 is an exploded perspective view of a mobile phone having a capacitor sensor in accordance with the present invention.

FIG. 2 is a detailed top view of the mobile phone shown in FIG. 1.

FIG. 3 illustrates a user's hand positioned in the proximity of the mobile phone shown in FIGS. 1 and 2.

FIG. 4 illustrates an exemplified sensing circuit for the capacitive proximity sensor compatible with the mobile phone shown in FIGS. 1 and 2.

FIGS. 5A and 5B show the detection of a change in capacitance when a user's hand moves close to the mobile phone in accordance with the present invention.

FIG. 6 illustrates a user's hand touching the mobile phone shown in FIGS. 1 and 2.

FIG. 7 illustrates a user's hand holding the mobile phone shown in FIGS. 1 and 2.

FIG. 8 is a perspective exploded view of another mobile phone having a different capacitor sensor in accordance with the present invention.

FIG. 9 is a perspective exploded view of another mobile phone having a different capacitor sensor in accordance with the present invention.

FIG. 10 illustrates another exemplified sensing circuit for a capacitive sensor in a mobile phone in accordance with the present invention.

### DETAILED DESCRIPTION OF THE INVENTION

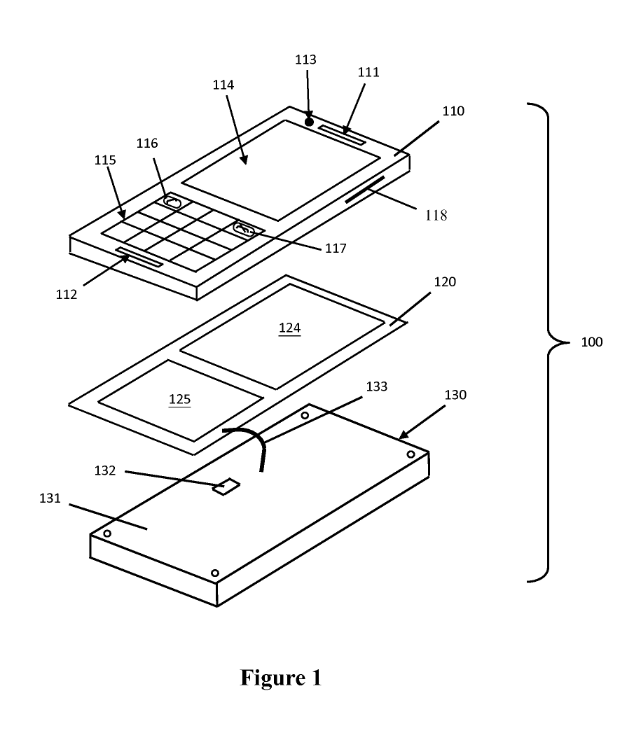

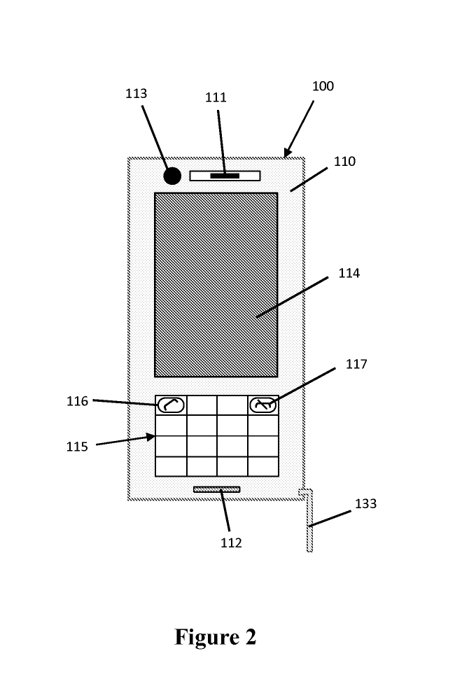

Referring to FIGS. 1 and 2, a mobile phone 100 includes a top case 110, a capacitive sensor 120, and a bottom case 130. The top case 110 can include microphone 111, a speaker 112, and a camera 113. The top case 110 can also include a display window 114 and a keypad 115 that includes a call button 116 and a cancel button 117. The top case 110 can also a wheel 118 for include a volume control.

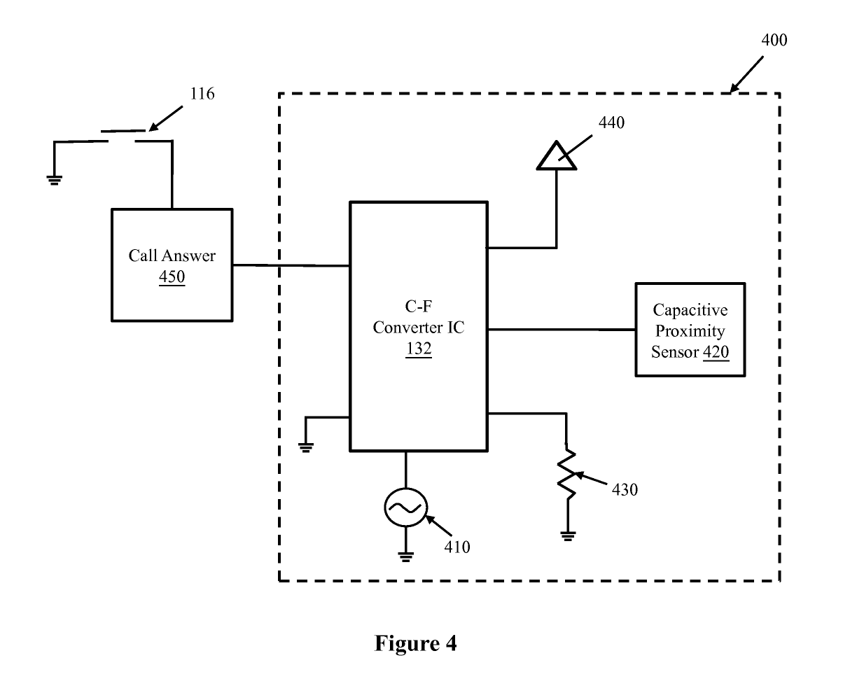

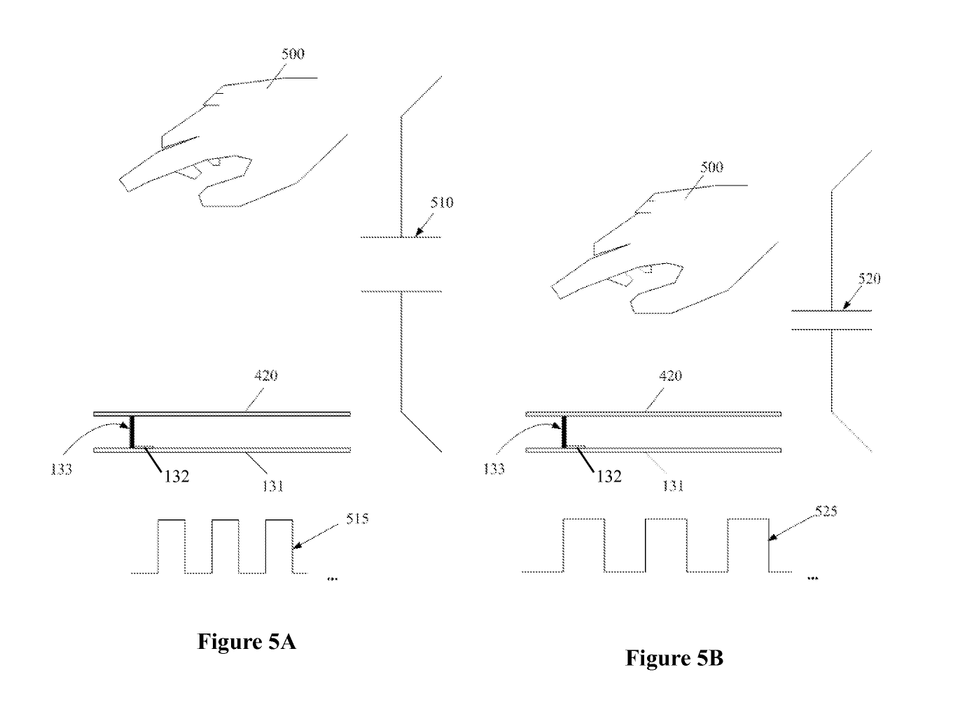

The capacitive sensor 120 can be in the shape of plate frame comprising openings 124, 125 that are to be positioned under for the display window 114 and the key pad 115 in the top case 110. The capacitive sensor 120 can be made of a conductive material such as a metal, an alloy, a conducting polymer, etc. The capacitive sensor 120 can operate as a capacitive proximity sensor (420 as shown in FIGS. 4 and 5) and a capacitive touch sensor, as described below.

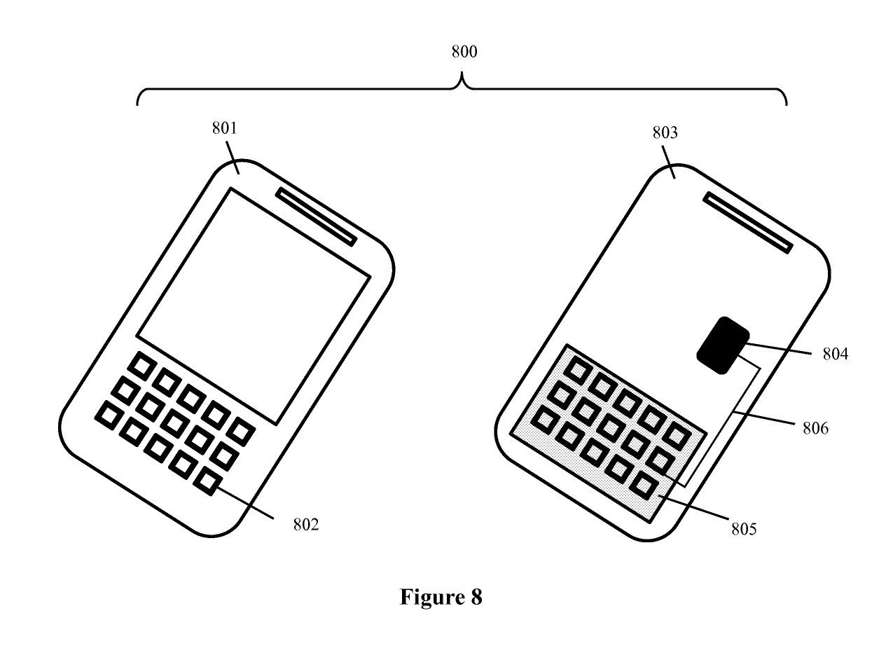

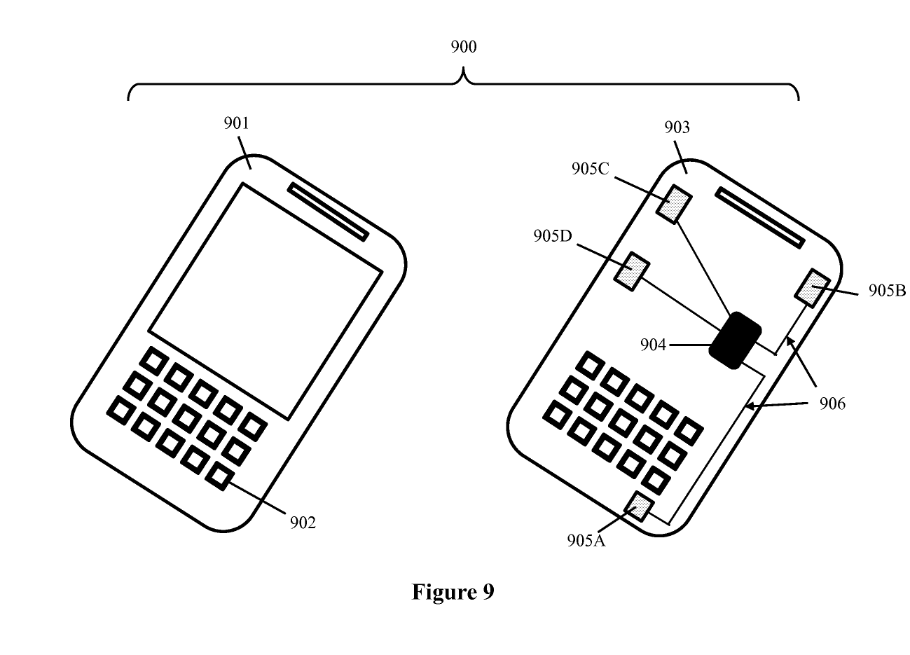

An important feature of the capacitive sensor 120 is that the capacitance of the capacitive sensor 120 is determined by a single electrode. The sensing circuit, as described below (e.g. in relation to FIG. 9), can include a plurality of such single-electrode capacitive sensors, which allows flexibility in its configurations. The capacitive sensor 120 can take many different shapes and placed in different locations of the mobile phone 100, for example, in the form a plate frame as shown in FIG. 1 and in another shape and location as shown in FIG. 8 below.

The bottom case 130 can include electronic circuit for controlling the operations (answer calls, display, sensors, clock, etc.) of the mobile phone 100, which includes a circuit board 131 and a C-F converter integrated circuit (IC) 132 which enables the detection of a user's hand. The C-F converter integrated circuit (IC) 132 can be mounted on or separate from the circuit board 131. The capacitive sensor 120 is connected to the C-F converter IC 132 by a connector wire 133. The capacitive sensor 120 is separated from the other parts of the lower case 130 by an insulating material (not shown).

A user can answer an incoming call on the mobile phone 100 by pressing the call button 116. In accordance with the present invention, the capacitive sensor 120 and associated sensing circuit (e.g. 400 in FIG. 4) also allow a user to answer a call without pressing a button in the keypad 115. As described in more detail below, a phone call be answered or another particular function can be activated on the mobile phone 100 by moving a hand in the vicinity of the mobile phone 100, or touching the mobile phone 100, or holding the mobile phone 100 in a specific position.

### Capacitive Proximity Sensor

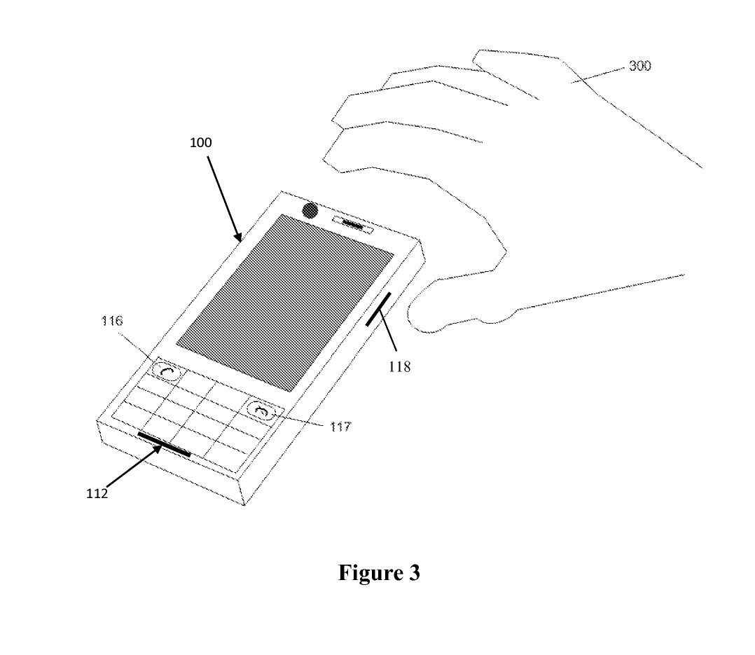

As shown in FIG. 3, when the mobile phone 100 receives an incoming call, a user can answer the incoming call moving her hand 300 toward the mobile phone 100. When the capacitive proximity sensor 420 detects that the hand 300 is in the proximity, the mobile phone 100 can automatically switches to a voice input path to the speaker 112, or other desired answering-mode.

Referring to FIG. 4, an exemplified sensing circuit 400 includes a capacitive proximity sensor 420 and a capacitance-to-frequency (C-F) converter IC 132 connected to the capacitive proximity sensor 420. An oscillator 410 is configured to apply an oscillating signal to the capacitive proximity sensor 420. The oscillator 410 can be internal or external to the sensing circuit 400. Depends on the characteristics of the C-F converter IC 132, the C-F converter IC 132 can be connected to passive components such as resistor 430, a capacitor (not shown), a high voltage supply 440, and the ground. A call answer circuit 450 in the circuit board 131 can receive input signals from and can be activated by the answer button 116 and the C-F converter IC 132. A user can also press the answer button 116 to activate the call answer circuit 450.

The capacitance of the capacitive proximity sensor 420 is dependent on the object in the vicinity around it (i.e. an electrode). When the user's hand moves to the vicinity of the mobile phone 100, the air next to the capacitive proximity sensor 420 is replaced by the user's hand. The capacitive proximity sensor 420 can be calibrated to be most sensitive to human hand. The change in dielectric constant induced by the user's hand and the associated change in the capacitance in the capacitive proximity sensor 420 can be detected by the sensing circuit 400, which is used to determine the presence of the user's hand.

In operation, an oscillating electric signal at a certain frequency is sent to the capacitive proximity sensor 420, which produces an electromagnetic field around the single electrode of the capacitive proximity sensor 420. When a user's hand is moved into the electromagnetic field around the capacitive proximity sensor 420, the dielectric constant and thus the capacitance change, which in turn changes the frequency of the oscillating electric signal. The C-F converter IC 132 is configured to measure the frequency of the alternating electric signal in the sensing circuit, and convert the measured frequency to a capacitance value in the capacitive proximity sensor 420. The conversion can be conducted using a pre-calibrated relationship between the oscillating frequency and capacitance of known object near or in touch of the mobile phone.

A change in the frequency can thus be used as an indicator for the presence of a user's hand in the proximity of the mobile phone 100. A user's hand is determined to be in presence near the mobile phone 100 when the capacitance of the capacitive sensor changes by a predetermined amount or reaches a predetermined value. Once the user's hand is detected, the C-F converter IC 132 sends a control signal to the call answer circuit 450 to activate the call answer function.

FIGS. 5A and 5B show the effects of the distance of a hand to the mobile phone 100. In FIG. 5A, the user's hand 500 is relatively far away from the capacitive proximity sensor 420 in the mobile phone 100. The capacitive proximity sensor 420 is connected to the C-F converter IC 132 on the circuit board 131. The capacitive proximity sensor 420 has a capacitance 510, which results an oscillating electric signal 515 in the sensing circuit (e.g. 400, FIG. 4). In FIG. 5B, the user's hand 500 is moved to the vicinity of the capacitive proximity sensor 420, which results in a capacitance 520 and an oscillating electric signal 525. The capacitance 510 when the hand 500 is far away from the mobile phone 100 is much larger than the capacitance 520 when the hand is placed close to the mobile phone 100. As a result, the oscillating electric signal 515 has a higher frequency than the frequency of the oscillating electric signal 525. The C-F converter IC 132 can measure and convert the frequencies in the oscillating signals 515, 525 to capacitances 510, 520. The absolute frequency value or a change in frequency can be used to determine the presence of the user's hand. The presence of the user's hand can be confirmed when the capacitance of the capacitive proximity sensor 420 changes by a predetermined amount or reaches a predetermined value.

### Capacitive Touch Sensor

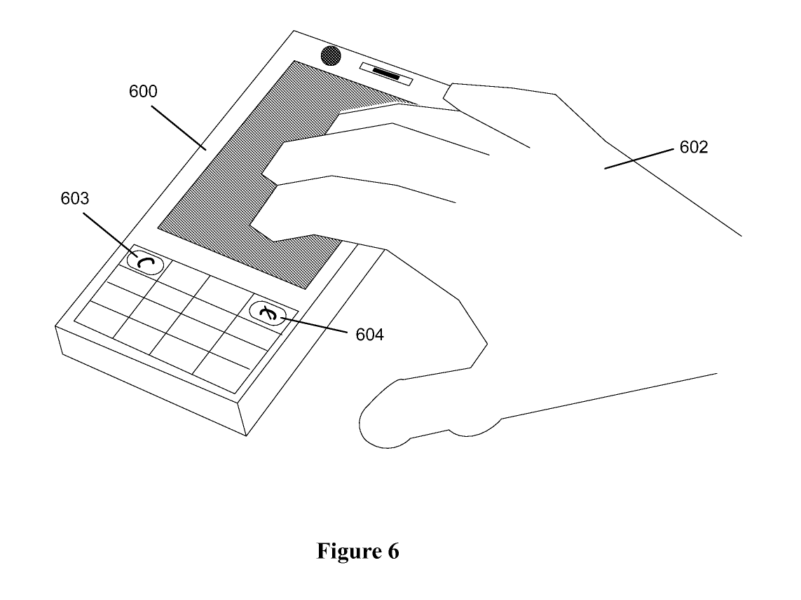

In some embodiments, the capacitor sensor can also operate as a touch sensor. As shown in FIG. 6, a mobile phone 600 includes a call button 603 and a cancel button 604, as well as capacitive touch sensor (not visible) under the top case, similar to mobile phone 100 as shown in FIGS. 1 and 2. The capacitive touch sensor determines a touch state by detecting the change in capacitance, similar to the descriptions above in relation to FIGS. 4, 5A, and 5B. When the mobile phone is not touched, the sensing circuit has a base capacitance contributed by the ground in the sensing circuit. When an incoming call is received by the mobile phone 600, a user can touch the mobile phone 600 with his hand 602. The total capacitance of the capacitive touch sensor increases, which leads to a decrease in the frequency of the oscillating signal in the sensing circuit. The C-F converter IC can measure the absolute frequency value or the change in frequency and calculate the change in the capacitance to recognize that the mobile phone 600 is touched the user's hand.

In some embodiments, the mobile phones (e.g. 100 in FIGS. 1 and 2) in accordance with the present application can also identify the movement in a user's body. A user's movement, such as hand waving, can produce changes in capacitance in the capacitance sensor, and in turn in the frequency of the oscillating signal in the sensing circuit. If the change in the frequency matches the pattern of change corresponding to a hand waving movement, the mobile phone can recognize the pattern, and answers an incoming call or activate other actions in the mobile phone.

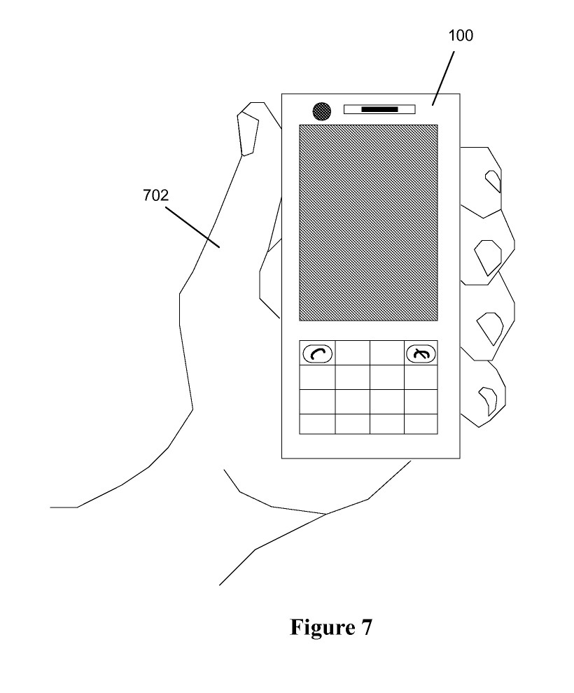

In some embodiments, the mobile phone in accordance with the present application can identify the specific position and/or orientation of a user's hand relative to the mobile phone. As shown in FIG. 7, a user's hand 702 is holding a mobile phone 100 which includes a capacitive sensor as described above. The mobile phone 100 measure the capacitance in the capacitive sensor by measuring the frequency of the oscillating signal in the sensing circuit. When the predetermined capacitance is identified, the mobile phone 100 can activate to call answering or other functions.

The capacitive sensor can include different layouts and configurations without deviating from the spirit of the present invention. For example, referring to FIG. 8, a mobile phone 800 includes a case 801 and a circuit board 803 under the case 801. On the case 810 there is a key pad 802. A C-F converter IC 804 and a single-electrode sensor plate 805 can be located on the circuit board 803. The sensor plate 805 is located under the key pad 802 when the mobile phone 800 is assembled together. The C-F converter IC 804 is connected to the sensor plate 805 by a connecting wire 806.

In another example, referring to FIG. 9, a mobile phone 900 includes a case 901 and a circuit board 903 under the case 901. A key pad 902 is positioned on the case 910. A C-F converter IC 904 can be located on the circuit board 903. The mobile phone can include a plurality of sensors 905A-905D at different locations. The C-F converter IC 904 is connected to the sensors 905A-905D by connecting wire 906. Each sensor 905A-905D includes a single electrode for measuring its respective capacitance. The C-F converter IC 904 can determine the position of a hand relative to each of the sensors 905A-905D. An oscillating signal is directed to each of the sensors 905A-905D; the frequency of the oscillating signals are respectively measured and the capacitance of each of the sensors 905A-905D computed by the C-F converter IC 904.

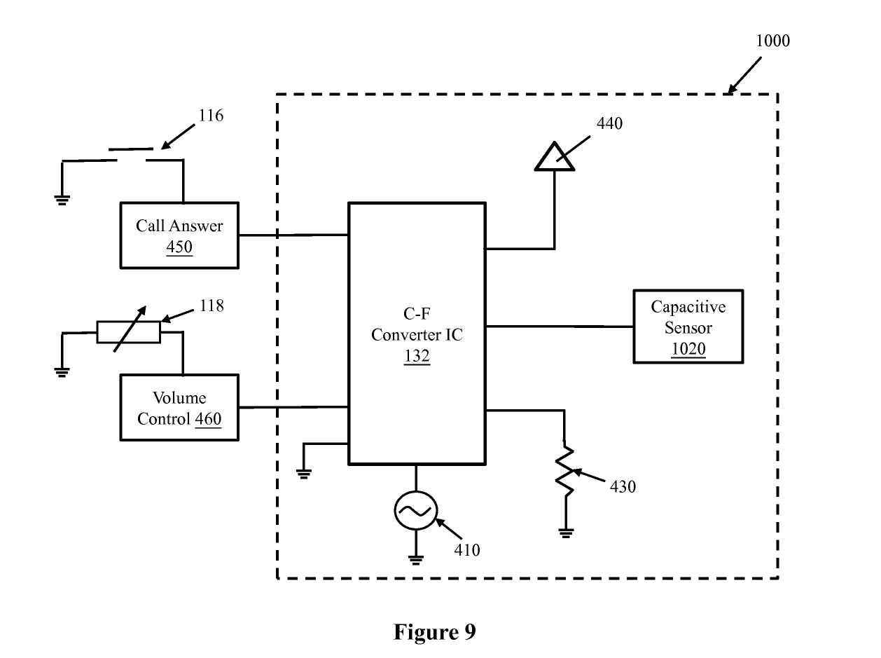

As seen in FIGS. 1-9 above, each capacitive proximity or capacitive touch sensor involves a single electrode in the sensing circuit. The mobile device can include a plurality of such sensors to determine a user's hand position. The sensor can be of a small size, flexible in shape and dimensions. These features allow significant flexibility in sensor designs. It should be noted that the disclosed mobile phones can switch on a different function from answering a phone call when the user's hand is detected in the proximity of or in touch with the phone's body. The different functions can include, for example, silencing the ring tone during a meeting, change the ring volume to a vibration mode, etc. Referring to FIG. 10, an exemplified sensing circuit 1000 includes a capacitive sensor 1020 and other similar components as the sensing circuit 400 as shown in FIG. 4 and described above. The capacitive sensor 1020 can be a capacitive proximity sensor or a capacitive touch sensor. The C-F converter IC 132 can control the call answer circuit 450 as described above. In addition, the C-F converter IC 132 is connected to a volume control circuit 460. The volume control circuit 460 can be controlled manually by dialing the wheel 118. The volume control circuit 460 can also be controlled by the C-F converter IC 132 in response to the position of the user' hand relative to the mobile phone. The volume control can include changing the volume of the speaker, silence the phone ring, and changing the phone to a vibration mode. The sensing circuit 1000 for example allows a user to hold a mobile phone in certain positions in his/her pocket to silence the mobile phone without looking at the phone or taking the phone out of the pocket. In accordance to the present invention, the sensing circuit 1000 can detect multiple of positions of a user's hand relative to the mobile phone. The different user's hand positions can produce different capacitances in the capacitive sensor and oscillating frequencies in the sensing circuit 1000: for example, a first capacitance and a first oscillating frequency for call answering, and a second capacitance and a second oscillating frequency for volume adjustment. By distinguishing the different capacitance and oscillating frequencies as described above, the C-F converter IC 132 can initiate different functions on the mobile phone in response to different positions of the user's hand.

It is understood that the disclosed circuit and methods are compatible with other configurations of the electronic components and variations in circuit designs without deviation from the spirit of the present specification. The presently disclosed apparatus is applicable to different types of telecommunication devices that can receive calls, such as cell phones, cordless phone, family radio service (FRS), Walkie-talkie, etc. To answer a call, the disclosed device can be picked up, switched on, or connected by proximity detection or holding of the device without pressing any key or button.

An advantage of the presently disclosed mobile device is that each capacitive sensor does not require a pair of electrodes for detecting the capacitance between the two electrodes. As it is know, a pair of electrodes is restricted in design configurations (positions, size, and shape). The disclosed mobile devices therefore can simplify device design and construction, and reduce costs.

Furthermore, the sensing circuit disclosed above is intended to illustrate, and not to limit, the present invention. Many other circuit designs can achieve the described functions while still being compatible with the present invention. The capacitance of the capacitive sensor can also be measured in different manners. For example, different waveforms can be used in the oscillating sensing signals.

What is claimed is:

1. A mobile communication device, comprising:
a device body;
one or more capacitive sensors each having a single electrode;
an oscillator configured to generate an oscillating signal applied to each of the one or more capacitive sensors;
a capacitance-frequency converter circuit configured to convert the frequency of the oscillating signal to the capacitance of each of the one or more capacitive sensors; and
a call-answer circuit coupled to the capacitance-frequency converter circuit, wherein the call-answer circuit is configured to be activated when the capacitance of the capacitive sensor changes by a predetermined amount or reaches a predetermined value when a user's hand moves to the proximity of the device body or touches the device body.

2. The mobile communication device of claim 1, wherein each of the one or more capacitive sensors is configured to change its capacitance when a user's hand is in the proximity of but not in touch with the device body.

3. The mobile communication device of claim 1, wherein each of the one or more capacitive sensors is configured to change its capacitance when a user's hand is in touch with the device body.

4. The mobile communication device of claim 1, wherein the device body includes a top case and a bottom case, wherein the single electrode of one of the one or more capacitive sensors is positioned between the top case and the lower case.

5. The mobile communication device of claim 4, wherein the top case includes a display window and a keypad, wherein the single electrode has the form of a plate having openings under the display window and the keypad.

6. The mobile communication device of claim 4, wherein the top case includes a display window and a keypad, wherein the single electrode is in the form of a plate and is positioned under the keypad.

7. The mobile communication device of claim 1, further comprising an answer button on the device body, wherein the call-answer circuit is coupled to the answer button and is configured to be activated when the answer button is pressed.

8. A mobile communication device, comprising:
a device body;
one or more capacitive sensors each having a capacitance that varies depending on a user's hand position in the vicinity of the mobile communication device;
an oscillator configured to generate an oscillating signal applied to each of the one or more capacitive sensors;
a capacitance-frequency converter circuit configured to convert the frequency of the oscillating signal to the capacitance of each of the one or more capacitive sensors;
a call-answer circuit coupled to the capacitance-frequency converter circuit; and
a volume-control circuit coupled to the capacitance-frequency converter circuit, wherein the capacitance-frequency converter circuit is configured to activate the call-answer circuit in response to a first position of the user's hand and to activate the volume-control circuit in response to a first position of the user's hand.

9. The mobile communication device of claim 8, wherein at least one of the one or more capacitive sensors includes a single electrode.

10. The mobile communication device of claim 8, wherein at least one of the one or more capacitive sensors is configured to change its capacitance when a user's hand is in the proximity of the device body or in touch with the device body.

12. The mobile communication device of claim 8, wherein at least one of the one or more capacitive sensors has a first capacitance when the user's hand is at the first position and a second capacitance when the user's hand is at the second position.

13. The mobile communication device of claim 12, wherein the capacitance-frequency converter circuit is configured to convert a first frequency of the oscillating signal to the first capacitance when the user's hand is at the first position, and wherein the capacitance-frequency converter circuit configured to convert a second frequency of the oscillating signal to the second capacitance when the user's hand is at the second position.

14. The mobile communication device of claim 8, wherein the device body includes a top case and a bottom case, wherein the single electrode of one of the one or more capacitive sensors is positioned between the top case and the lower case.

15. The mobile communication device of claim 14, wherein the top case includes a display window and a keypad, wherein the single electrode has the form of a plate having openings under the display window and the keypad.

16. The mobile communication device of claim 14, wherein the top case includes a display window and a keypad, wherein the single electrode is in the form of a plate and is positioned under the keypad.

17. A mobile communication device, comprising:
a device body;
one or more capacitive sensors each having a single electrode that varies depending on a user's hand position in the vicinity of the mobile communication device;
an oscillator configured to generate an oscillating signal applied to each of the one or more capacitive sensors; and
a capacitance-frequency converter circuit configured to convert the frequency of the oscillating signal to the capacitance of each of the one or more capacitive sensor, wherein the capacitance-frequency converter circuit is configured to activate a plurality of functions in response to different positions of the user's hand in the vicinity of the device body.

18. The mobile communication device of claim 17, wherein the plurality of functions comprise call answering, volume control, volume silencing, or the turning on the vibration mode.

19. The mobile communication device of claim 17, wherein the user's hand at different positions is configured to change the capacitances of the one or more capacitive sensor by predetermined amounts or to predetermined values.

20. The mobile communication device of claim 17, wherein the one or more capacitive sensor are configured to change their respective capacitances when the user's hand is in the proximity of the device body or in touch with the device body.
